(19) United States
(12) Patent Application Publication
(10) Pub. No.: US 2019/0312377 A1
(43) Pub. Date: Oct. 10, 2019

(54) MULTI-PIECE CASSETTE

(71) Applicant: The Siemon Company, Watertown, CT (US)

(72) Inventors: Martin Harisi, Wolcott, CT (US); Brian McCaffrey, Woodbury, CT (US)

(21) Appl. No.: 16/377,816

(22) Filed: Apr. 8, 2019

Related U.S. Application Data
(60) Provisional application No. 62/654,595, filed on Apr. 9, 2018.

(51) Int. Cl. H01R 13/514; H01R 13/73

(52) U.S. Cl. CPC H01R 13/514; H01R 24/64; H01R 13/73

(57) ABSTRACT

A multi-piece cassette including a first portion having a plurality of first ports; a second portion having a plurality of second ports; the first portion including a first joining portion; the second portion including a second joining portion; wherein when the first joining portion and the second joining portion are connected, the first ports of the first portion and second ports of the second portion are aligned on a common, single axis.

### CROSS-REFERENCE TO RELATED APPLICATIONS

This application claims the benefit of U.S. provisional patent application Ser. No. 62/654,595, filed Apr. 9, 2018, the entire contents of which are incorporated herein by reference.

### TECHNICAL FIELD

The subject matter disclosed herein relates generally to cable assemblies, and more particularly, to a multi-piece cassette for use in a cable assembly.

### BACKGROUND

FIG. 1 depicts a cable assembly 10 having a cassette 12 on each end of a bundle of cables 16. Each cassette 12 houses a plurality of individual telecommunications connectors 14 (e.g., six telecommunications connectors in each cassette). The plurality of telecommunications connectors 14 are connected by the bundle of cables 16 (e.g., six cables, each cable having eight wires). Pulling a cable assembly 10 of this type through an installation area of walls, conduits, and/or narrow spaces to a telecommunications closet is challenging and limited by the size of the cassette 12.

### SUMMARY

A multi-piece cassette including a first portion having a plurality of first ports; a second portion having a plurality of second ports; the first portion including a first joining portion; the second portion including a second joining portion; wherein when the first joining portion and the second joining portion are connected, the first ports of the first portion and second ports of the second portion are aligned on a common, single axis.

### BRIEF DESCRIPTION OF THE DRAWINGS

Referring now to the drawings wherein like elements are numbered alike in the FIGURES:

FIG. 1 depicts a conventional cable assembly;

FIG. 2 is a top view of a multi-piece cassette in an example embodiment;

FIG. 3 is a perspective view of the multi-piece cassette in an example embodiment;

FIG. 4 is an enlarged view of a portion of FIG. 3;

FIG. 5 is a front view of the multi-piece cassette in an example embodiment;

FIG. 6 is perspective view of the multi-piece cassette rearranged in an example embodiment;

FIG. 7 is perspective view of the multi-piece cassette mounted in a flat patch panel;

FIG. 8 is perspective view of the multi-piece cassette mounted in an angled patch panel.

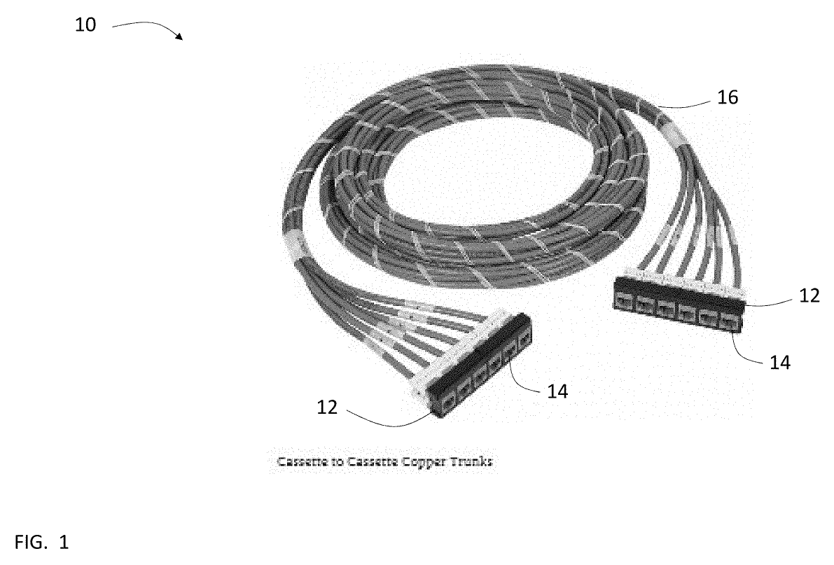

### DETAILED DESCRIPTION

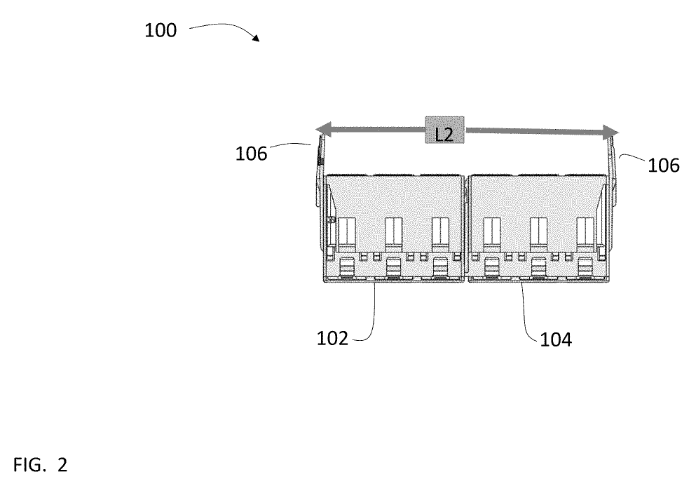

FIG. 2 is a top view of a multi-piece cassette 100 in an example embodiment. The multi-piece cassette 100 includes a first portion 102 and a second portion 104. Each of the first portion 102 and the second portion 104 includes a tab 106 to secure the multi-piece cassette 100 to an opening in a patch panel. The first portion 102 and the second portion 104 are separable.

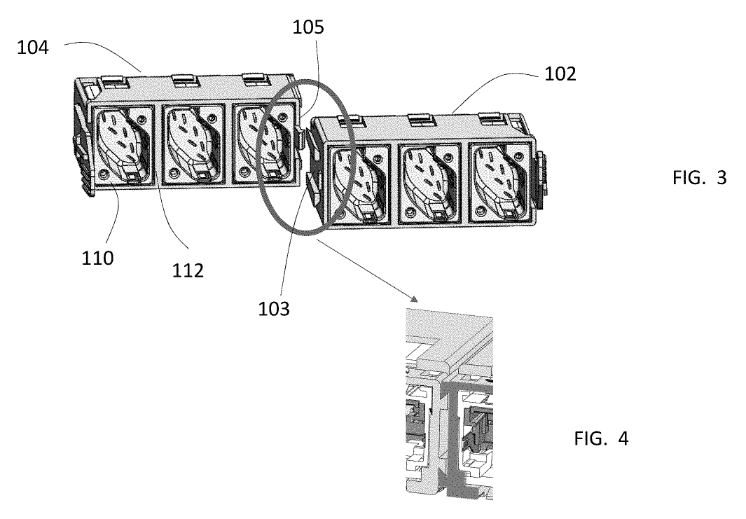

FIG. 3 is perspective view of the multi-piece cassette 100 showing the first portion 102 detached from the second portion 104. The top and bottom of the first portion 102 are parallel. The side walls of the first portion 102 are perpendicular to the top and bottom. Second portion 104 is constructed in a similar manner The first portion 102 and the second portion 104 each include a joining structure 103 and 105, respectively, to removably couple the first portion 102 and the second portion 104. Joining structures 103 and 105 are formed on the interior side walls of the first portion 102 and the second portion 104. In one embodiment, the joining structure 103/105 is in the form of a dovetail joint. FIG. 4 is an exploded view of the joining structure 103/105 of FIG. 3. Embodiments may use other joining structures such as pins/holes, biscuit joints, finger joints, mortise/tenon joints, tongue/groove joints, etc. The joining structures 103 and 105 are configured to coact mechanically to removable secure the first portion 102 to the second portion 104.

Also depicted in FIG. 3 is a telecommunications connector 110 received in each port 112 of the first portion 102 and the second portion 104 of the multi-piece cassette 100. Telecommunications connector 110 may be an outlet, adapter, coupler, plug, etc., and may terminate to a variety of types of cable, including copper, optical fiber, coax, etc.

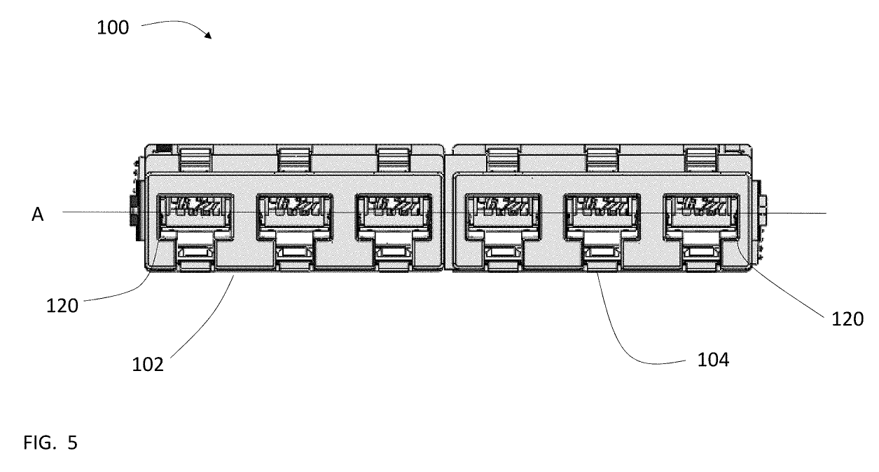

FIG. 5 is a front view of the multi-piece cassette 100. The multi-piece cassette 100 includes openings 120 on a front face thereof to receive a mating telecommunications connector that connects with telecommunications connector 110 in each port 112. When coupled by the joining structures 103/105, the openings 120 and the ports 112 of the first portion 102 and the second portion 104 are aligned on a common, single axis, A.

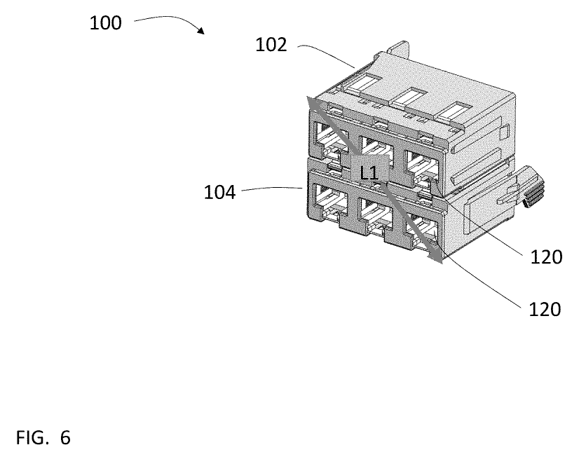

FIG. 6 is perspective view of the multi-piece cassette 100 rearranged in an example embodiment to facilitate pulling the cable assembly, including the multi-piece cassette 100, through installation areas. As shown in FIG. 6, the first portion 102 and second portion 104 are stacked over each other to minimize the overall length of multi-piece cassette 100 during cable pull. Another set of joining structures may be formed on the top and/or bottom of the first portion 102 and the second portion 104, to hold the first portion 102 and the second portion 104 in the stacked position shown in FIG. 6. The joining structures formed on the top and/or bottom of the first portion 102 and the second portion 104 may include a dovetail joint, pins/holes, biscuit joints, finger joints, mortise/tenon joints, tongue/groove joints, etc.

As shown in FIG. 2, the largest dimension of the multi-piece cassette 100 is L2, when first portion 102 and second portion 104 are joined side by side by the joining structure 103/105. By contrast, in FIG. 6 the largest dimension of the multi-piece cassette 100 is L1, when first portion 102 and second portion 104 are stacked one on top of the other. L1 is less than L2 which facilitates pulling the multi-piece cassette 100 through installation areas.

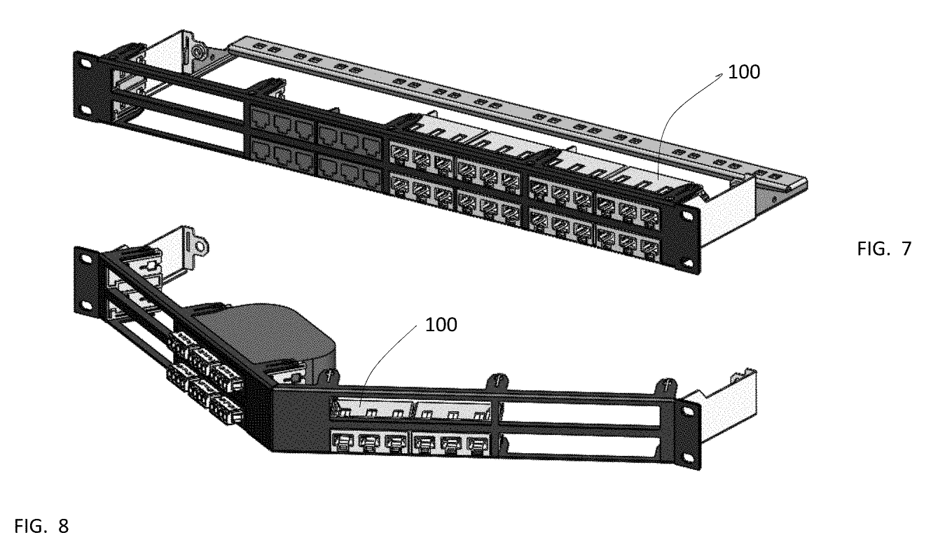

FIG. 7 is perspective view of the multi-piece cassette 100 mounted in a flat patch panel. FIG. 8 is perspective view of the multi-piece cassette 100 mounted in an angled patch panel. A multi-piece cassette 100 is inserted into panel with a simple push-in action and secured by tabs 106. For removal, the two rear tabs 106 are squeezed while pulling back on multi-piece cassette 100.

The multi-piece cassette 100 may be part of a cable assembly having a multi-piece cassette 100 attached to one or both ends of a cable bundle. When it is necessary to pull the cable assembly through an installation area, the first portion 102 and second portion 104 may be detached from each other and stacked (as shown in FIG. 6) to facilitate pulling the multi-piece cassette 100 through the installation area.

Embodiments described herein relate to a 6-port cassette that may be separated into two, 3-port cassettes. It is understood that the cassette may have more or less than 6 ports and may be divided into more than two portions. Further, the number of ports in each portion need not be equal.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as being limited by the foregoing description.

What is claimed is:

1. A multi-piece cassette comprising:
a first portion having a plurality of first ports;
a second portion having a plurality of second ports;
the first portion including a first joining portion;
the second portion including a second joining portion;
wherein when the first joining portion and the second joining portion are connected, the first ports of the first portion and second ports of the second portion are aligned on a common, single axis.

2. The multi-piece cassette of claim 1 wherein the first joining portion and second joining portion removably secure the first portion to the second portion.

3. The multi-piece cassette of claim 1 wherein a number of first ports is three and a number of second ports is three.

4. The multi-piece cassette of claim 1 wherein a number of first ports is not equal to a number of second ports.

5. The multi-piece cassette of claim 1 further comprising a first tab on the first portion and a second tab on the second portion, the first tab and second tab configured to secure the multi-piece cassette to a panel.

6. The multi-piece cassette of claim 1 wherein:
the first joining portion is positioned on a first side of the first portion;
the second joining portion is positioned on a second side of the second portion;
the first portion including a bottom joining portion;
the second portion including a top joining portion;
wherein when the bottom joining portion and the top joining portion are connected, the first ports of the first portion and second ports of the second portion stacked above one another.

7. The multi-piece cassette of claim 1 further comprising a telecommunications connector positioned in at least one of the first ports or the second ports.

8. The multi-piece cassette of claim 1 further comprising a telecommunications connector positioned in each of the first ports and the second ports.
